(19) United States
(12) Patent Application Publication
(10) Pub. No.: US 2025/0160562 A1
(43) Pub. Date: May 22, 2025

(54) AUTOMATIC COFFEE BREWING DEVICE

(71) Applicant: YUNG-TSUNG KUO, New Taipei City (TW)

(72) Inventor: YUNG-TSUNG KUO, New Taipei City (TW)

(21) Appl. No.: 18/943,978

(22) Filed: Nov. 12, 2024

(30) Foreign Application Priority Data
Nov. 16, 2023 (TW) 112212469

(51) Int. Cl. A47J 31/52; A47J 31/057; A47J 31/08; A47J 31/42; A47J 31/44; A47J 31/46; A47J 31/54

(52) U.S. Cl. CPC A47J 31/52; A47J 31/0573; A47J 31/08; A47J 31/42; A47J 31/446; A47J 31/46; A47J 31/542

(57) ABSTRACT

An automatic coffee brewing device includes an electronic control mechanism, a rotating mechanism, a coffee filter paper installation mechanism, a coffee powder feeding mechanism, a brewing mechanism, a coffee holding mechanism, and a filter cup processing mechanism, and all are integrated on a support mechanism. The coffee brewing procedure is set via the electronic control mechanism, and the container is placed in the coffee holding mechanism. The rotating mechanism drives the filter cup movement, allowing the coffee filter paper installation mechanism to place filter paper in the filter cup, and the coffee powder feeding mechanism fills coffee grounds into the filter paper. The brewing mechanism then adds water to brew the coffee grounds, allowing the coffee liquid to be collected in the container. Subsequently, the filter cup processing mechanism cleans the used filter cup, thereby achieving the effects of labor savings, maintaining brewing quality, and improving brewing capacity.

### BACKGROUND OF THE INVENTION

### 1. Fields of the Invention

The present invention relates to an automatic coffee brewing device, and more particularly, to an automatic coffee brewing device that executes brewing of iced coffee or hot coffee according to set programs, thereby achieving labor savings, maintaining brewing quality, and improving brewing capacity.

### 2. Descriptions of Related Art

Generally, when brewing coffee, it is typically completed through multiple procedures done manually by human labor. However, brewing coffee through the aforementioned manual method lacks efficiency and does not meet the needs of modern people.

Therefore, the key objective the present invention actively seeks to disclose is how to create an automatic coffee brewing device that can execute brewing of iced coffee or hot coffee according to set programs, thereby achieving labor savings, maintaining brewing quality, and improving brewing capacity, effectively improving the deficiencies of conventional methods.

The present invention intends to provide an automatic coffee brewing device to eliminate the shortcomings mentioned above.

### SUMMARY OF THE INVENTION

The present invention relates to an automatic coffee brewing device and comprises a support mechanism, an electronic control mechanism, a rotating mechanism, a coffee filter paper installation mechanism, a coffee powder feeding mechanism, a brewing mechanism, a coffee holding mechanism, and a filter cup processing mechanism.

The electronic control mechanism is mounted on the support mechanism. The rotating mechanism is mounted on a top surface of the support mechanism and electrically connected to the electronic control mechanism. The coffee filter paper installation mechanism is mounted on the support mechanism and electrically connected to the electronic control mechanism. The coffee filter paper installation mechanism is located corresponding to the rotating mechanism. The coffee powder feeding mechanism is mounted on the support mechanism and electrically connected to the electronic control mechanism. The coffee powder feeding mechanism is located corresponding to the rotating mechanism. The brewing mechanism is mounted on the support mechanism and electrically connected to the electronic control mechanism. The brewing mechanism is located corresponding to the rotating mechanism. The coffee holding mechanism is mounted on the support mechanism and located corresponding to the brewing mechanism. The filter cup processing mechanism is mounted on the support mechanism and electrically connected to the electronic control mechanism. The filter cup processing mechanism is located corresponding to the rotating mechanism.

Preferably, the support mechanism includes a base and a cover. The electronic control mechanism, the rotating mechanism, the coffee filter paper installation mechanism, the coffee powder feeding mechanism, the brewing mechanism, the coffee holding mechanism, and the filter cup processing mechanism are mounted on the base. The cover is combined with the base, and at least encloses the rotating mechanism, the coffee filter paper installation mechanism, the coffee powder feeding mechanism, the brewing mechanism, and the filter cup processing mechanism.

Preferably, the rotating mechanism is located at the central position of a front side of the base. The coffee filter paper installation mechanism is mounted at a rear side of the rotating mechanism. The coffee powder feeding mechanism is correspondingly mounted above the rotating mechanism and adjacent to the coffee filter paper installation mechanism. The brewing mechanism is correspondingly mounted above the rotating mechanism and adjacent to the coffee powder feeding mechanism. The coffee holding mechanism is mounted at a lower front side of the base, and the filter cup processing mechanism is mounted on one side of the rotating mechanism.

Preferably, a waste collection mechanism is mounted below the support mechanism and located corresponding to the filter cup processing mechanism.

Preferably, the electronic control mechanism includes an operation setting module and a pneumatic distribution module. The pneumatic distribution module, the rotating mechanism, the coffee filter paper installation mechanism, the coffee powder feeding mechanism, the brewing mechanism, and the filter cup processing mechanism are electrically connected to the operation setting module. The pneumatic distribution module provides a control air pressure for operation of the coffee filter paper installation mechanism, the brewing mechanism, and the filter cup processing mechanism.

Preferably, the rotating mechanism includes a support plate and multiple placement areas. The placement areas are respectively located on a surface of the support plate, and a filter cup is placed on each placement area.

Preferably, the coffee filter paper installation mechanism includes a filter paper storage module and a filter paper picking and placing module. The filter paper storage module is mounted above the filter paper picking and placing module.

Preferably, the filter paper picking and placing module includes a first suction part, a second suction part, and a pressing part. The first suction part and the second suction part are located corresponding to each other. The pressing part is located between the first suction part and the second suction part.

Preferably, the coffee powder feeding mechanism includes a storage part and a coffee bean grinding and feeding machine. The storage part is mounted above the coffee bean grinding and feeding machine.

Preferably, the brewing mechanism includes a water supply module, a heating module, and a cooling module. The heating module is connected to the water supply module. The heating module is adapted to be connected to an external water source. The cooling module is mounted on the coffee holding mechanism.

Preferably, the water supply module includes a rotating nozzle, and the rotating nozzle has at least three water outlets.

Preferably, the heating module is an instant heating device for receiving water from an external water source and performing two-stage heating to control hot water temperature between 80° C. and 95° C., before transferring the hot water to the water supply module for output.

Preferably, the filter cup processing mechanism includes a driving module, a clamping module, and a cleaning mechanism. The clamping module is mounted on the driving module, and the cleaning mechanism is located below the support mechanism and located corresponding to the clamping module.

The primary object of the present invention is to provide an automatic coffee brewing device and sets coffee brewing procedures through an electronic control mechanism. When the container is placed in the coffee holding mechanism, a rotating mechanism drives the filter cup to move, allowing the coffee filter paper installation mechanism to place filter paper in the filter cup. The coffee powder feeding mechanism then fills coffee grounds into the filter paper, and the brewing mechanism adds water to brew the coffee grounds. This allows the coffee liquid to be collected in the container. Subsequently, the filter cup processing mechanism cleans the used filter cup, thereby achieving the effects of labor savings, maintaining brewing quality, and improving brewing capacity.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is the first perspective view of a preferred embodiment of the automatic coffee brewing device of the present invention;

FIG. 2 is the second perspective view of a preferred embodiment of the automatic coffee brewing device of the present invention;

FIG. 3 is the third perspective view of a preferred embodiment of the automatic coffee brewing device of the present invention;

FIG. 4 is the front view of a preferred embodiment of the automatic coffee brewing device of the present invention;

FIG. 5 is the first side view of a preferred embodiment of the automatic coffee brewing device of the present invention, and

FIG. 6 is the second side view of a preferred embodiment of the automatic coffee brewing device of the present invention.

### DETAILED DESCRIPTION OF THE PREFERRED EMBODIMENT

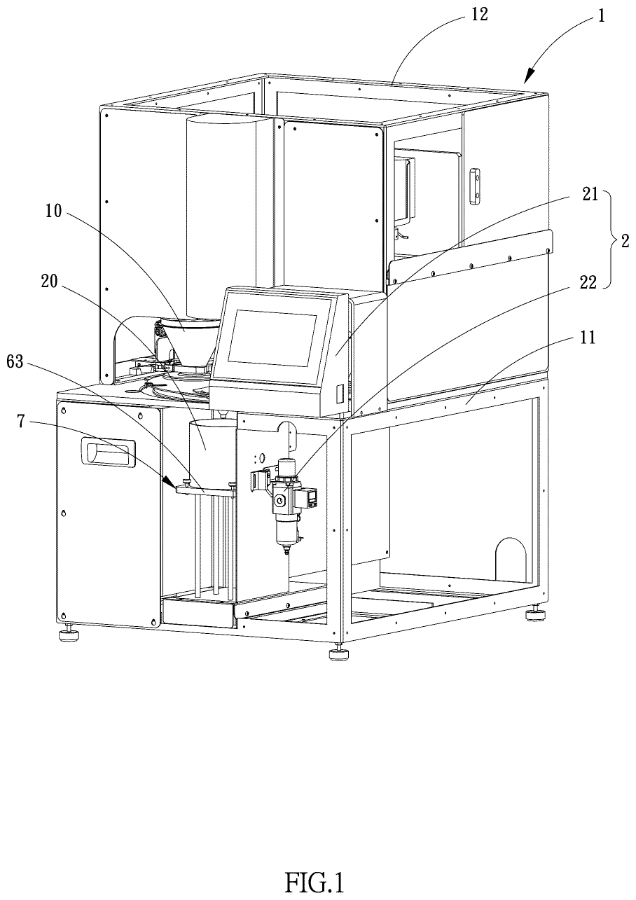

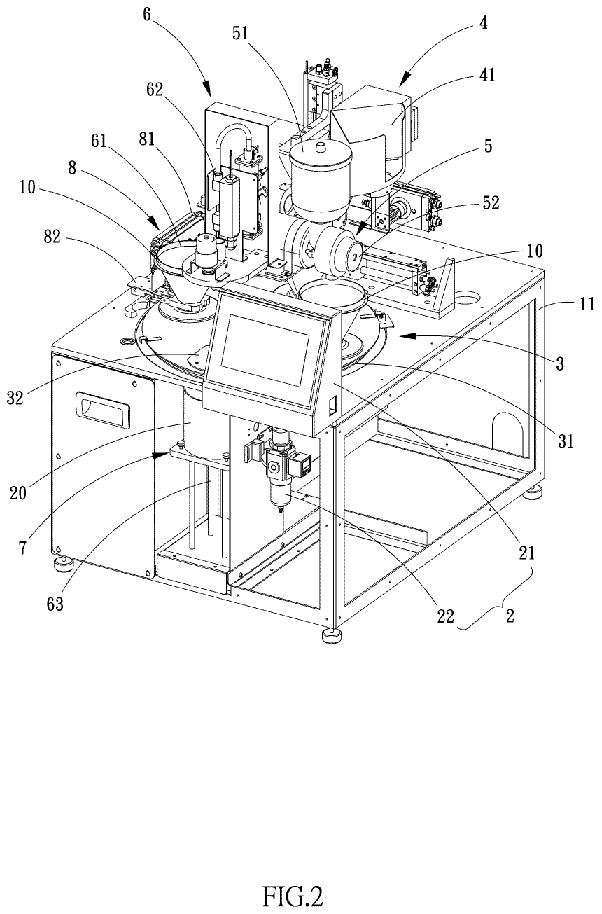

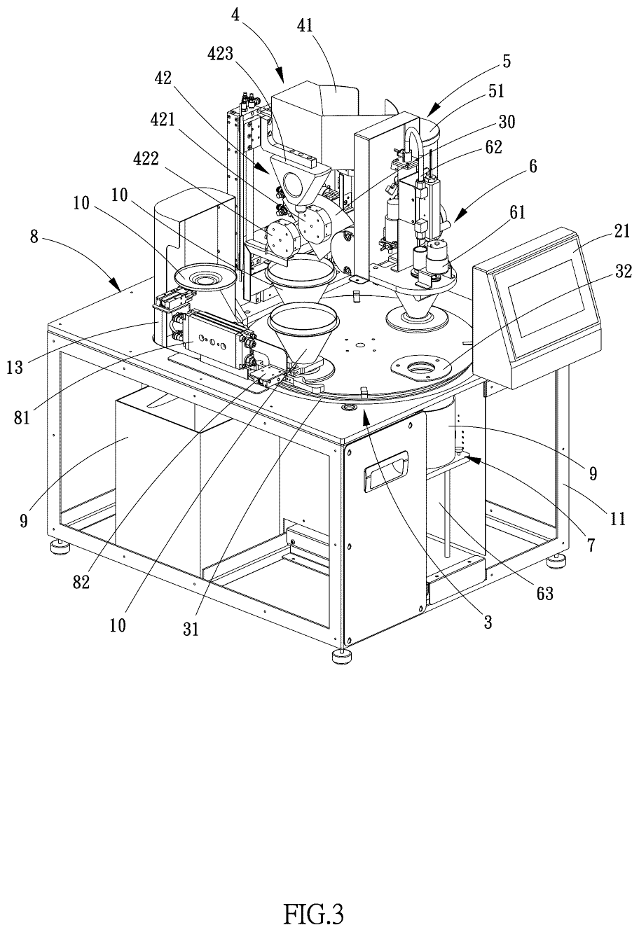

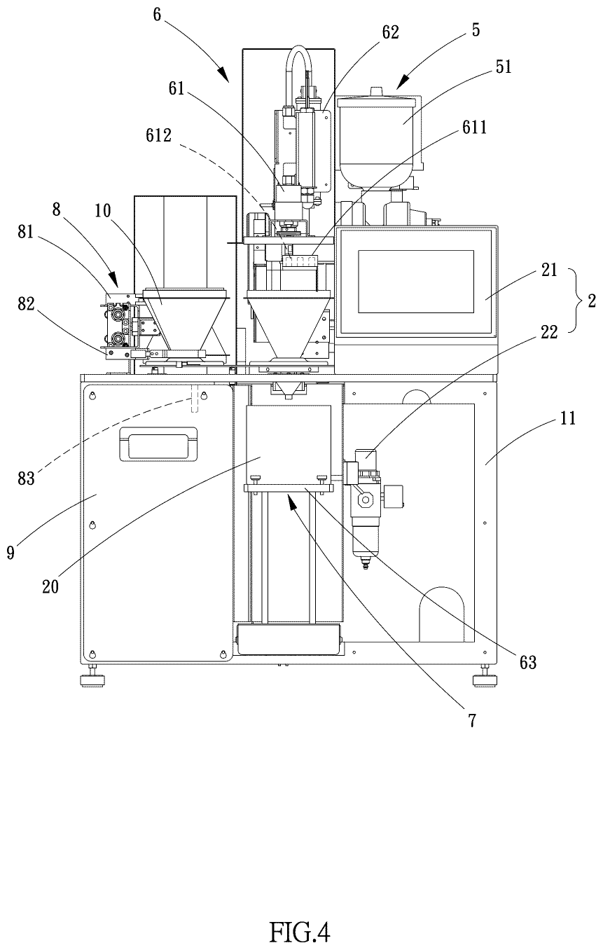

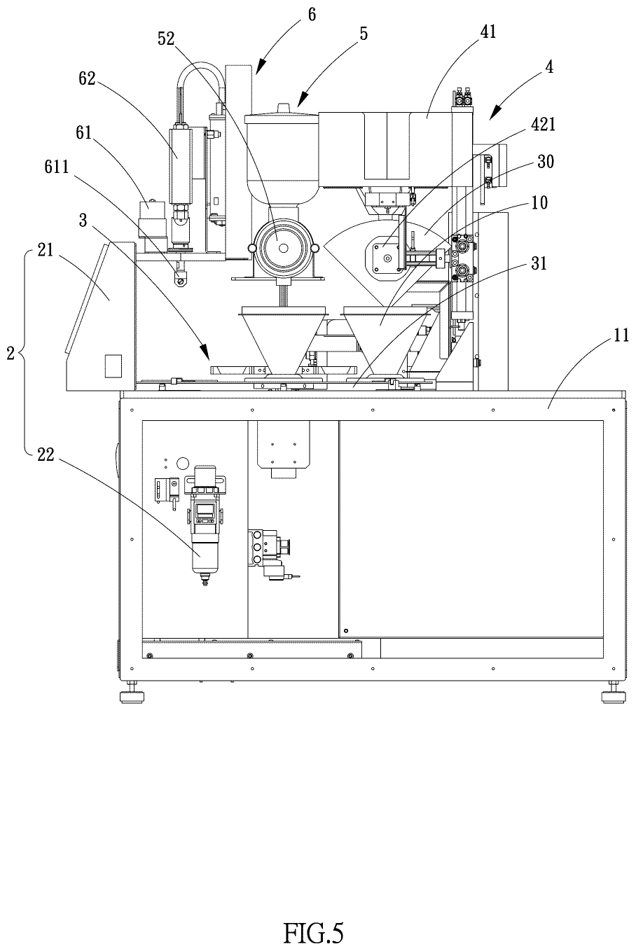

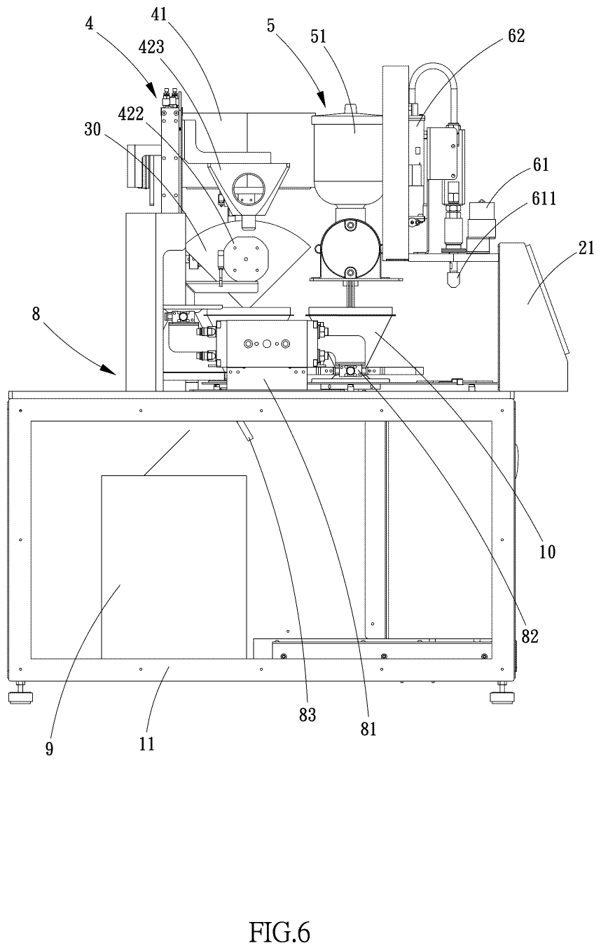

Referring to FIGS. 1 to 6, the automatic coffee brewing device of the present invention comprises a support mechanism 1, an electronic control mechanism 2, a rotating mechanism 3, a coffee filter paper installation mechanism 4, a coffee powder feeding mechanism 5, a brewing mechanism 6, a coffee holding mechanism 7, and a filter cup processing mechanism 8.

The electronic control mechanism 2 is mounted on the support mechanism 1. The rotating mechanism 3 is mounted on a top surface of the support mechanism 1 and electrically connected to the electronic control mechanism 2. The coffee filter paper installation mechanism 4 is mounted on the support mechanism 1 and electrically connected to the electronic control mechanism 2. The coffee filter paper installation mechanism 4 is located corresponding to the rotating mechanism 3. The coffee powder feeding mechanism 5 is mounted on the support mechanism 1 and electrically connected to the electronic control mechanism 2. The coffee powder feeding mechanism 5 is located corresponding to the rotating mechanism 3. The brewing mechanism 6 is mounted on the support mechanism 1 and electrically connected to the electronic control mechanism 2. The brewing mechanism 6 is located corresponding to the rotating mechanism 3. The coffee holding mechanism 7 is mounted on the support mechanism 1 and located corresponding to the brewing mechanism 6. The filter cup processing mechanism 8 is mounted on the support mechanism 1 and electrically connected to the electronic control mechanism 2. The filter cup processing mechanism 8 is located corresponding to the rotating mechanism 3.

When operating the present invention, the electronic control mechanism 2 performs the settings, activation, and related control procedures for the operation of the electronic control mechanism 2, the rotating mechanism 3, the coffee filter paper installation mechanism 4, the coffee powder feeding mechanism 5, the brewing mechanism 6, the coffee holding mechanism 7, and the filter cup processing mechanism 8.

After setting, multiple filter cups 10 are placed respectively on the rotating mechanism 3, and the container 20 is placed in the coffee holding mechanism 7. The rotating mechanism 3 rotates counterclockwise while moving these filter cups 10, and these filter cups 10 sequentially move through the positions of the coffee filter paper installation mechanism 4, the coffee powder feeding mechanism 5, the brewing mechanism 6, the coffee holding mechanism 7, and the filter cup processing mechanism 8.

When these filter cups 10 move sequentially in the aforementioned direction, the coffee filter paper installation mechanism 4 places filter paper 30 in each filter cup, and the coffee powder feeding mechanism 5 fills coffee grounds into the filter paper 30. The brewing mechanism 6 then adds hot water to brew the coffee grounds, allowing the coffee liquid to be collected in the container 20 of the coffee holding mechanism 7. Afterward, the filter cup processing mechanism 8 cleans the used filter cups 10, and the cleaned filter cups 10 are placed back on the rotating mechanism 3, allowing the coffee filter paper installation mechanism 4 to install filter paper 30 in the filter cups 10 for the next brewing cycle. Through this cyclic operation, automatic coffee brewing is executed.

Thus, through the explanation of the above embodiment, the present invention can set coffee brewing procedures through the electronic control mechanism 2, and place the container 20 in the coffee holding mechanism 7. The rotating mechanism 3 drives the movement of the filter cups 10, allowing the coffee filter paper installation mechanism 4 to place filter paper 30 in each filter cup 10, and the coffee powder feeding mechanism 5 fills coffee grounds into the filter paper 30. The brewing mechanism 6 then adds water to brew the coffee grounds, allowing the coffee liquid to be collected in the container 20. Subsequently, the filter cup processing mechanism 8 cleans the used filter cups 10, thereby achieving the effects of labor savings, maintaining brewing quality, and improving brewing capacity.

In one embodiment, the support mechanism 1 includes a base 11 and a cover 12. The electronic control mechanism 2, the rotating mechanism 3, the coffee filter paper installation mechanism 4, the coffee powder feeding mechanism 5, the brewing mechanism 6, the coffee holding mechanism 7, and the filter cup processing mechanism 8 are mounted on the base 11. The cover 12 is combined with the base 11, and at least encloses the rotating mechanism 3, the coffee filter paper installation mechanism 4, the coffee powder feeding mechanism 5, the brewing mechanism 6, and the filter cup processing mechanism 8. The rotating mechanism 3 is located at the central position of a front side of the base 11. The coffee filter paper installation mechanism 4 is mounted at a rear side of the rotating mechanism 3. The coffee powder feeding mechanism 5 is correspondingly mounted above the rotating mechanism 3 and adjacent to the coffee filter paper installation mechanism 4. The brewing mechanism 6 is correspondingly mounted above the rotating mechanism 3 and adjacent to the coffee powder feeding mechanism 5. The coffee holding mechanism 7 is mounted at a lower front side of the base 11, and the filter cup processing mechanism 8 is mounted on one side of the rotating mechanism 3. Through the arrangement of the positions of the electronic control mechanism 2, the rotating mechanism 3, the coffee filter paper installation mechanism 4, the coffee powder feeding mechanism 5, the brewing mechanism 6, the coffee holding mechanism 7, and the filter cup processing mechanism 8, cyclic operation can be quickly performed according to the brewing procedure, thereby achieving the effects of labor savings, maintaining brewing quality, and improving brewing capacity.

In one embodiment, the electronic control mechanism 2 includes an operation setting module 21 and a pneumatic distribution module 22. The pneumatic distribution module 22, the rotating mechanism 3, the coffee filter paper installation mechanism 4, the coffee powder feeding mechanism 5, the brewing mechanism 6, and the filter cup processing mechanism 8 are electrically connected to the operation setting module 21. The pneumatic distribution module 22 provides a control air pressure for operation of the coffee filter paper installation mechanism 4, the brewing mechanism 6, and the filter cup processing mechanism 8. The operation setting module 21 serves as a user interface located on outside of the cover 12. Thus, the operation setting module 21 can perform the settings, activation, and related control procedures for the operation of the electronic control mechanism 2, the rotating mechanism 3, the coffee filter paper installation mechanism 4, the coffee powder feeding mechanism 5, the brewing mechanism 6, the coffee holding mechanism 7, and the filter cup processing mechanism 8, facilitating the coffee brewing procedure and thereby achieving the effects of labor savings, maintaining brewing quality, and improving brewing capacity.

In one embodiment, the rotating mechanism 3 includes a support plate 31 and multiple placement areas 32. The placement areas 32 are respectively located on a surface of the support plate 31, and a filter cup 10 is placed on each placement area 32. Thus, the filter cups 10 can be placed respectively in the placement areas 32, and the support plate 31 rotates counterclockwise while moving these filter cups 10, allowing these filter cups 10 to sequentially move through the positions of the coffee filter paper installation mechanism 4, the coffee powder feeding mechanism 5, the brewing mechanism 6, the coffee holding mechanism 7, and the filter cup processing mechanism 8, facilitating the coffee brewing procedure and thereby achieving the effects of labor savings, maintaining brewing quality, and improving brewing capacity.

In one embodiment, the coffee filter paper installation mechanism 4 includes a filter paper storage module 41 and a filter paper picking and placing module 42. The filter paper storage module 41 is mounted above the filter paper picking and placing module 42. Multiple filter papers 30 are placed in the filter paper storage module 41. The filter paper picking and placing module 42 includes a first suction part 421, a second suction part 422, and a pressing part 423. The first suction part 421 and the second suction part 422 are located corresponding to each other. The pressing part 423 is located between the first suction part 421 and the second suction part 422.

When installing the filter paper 30 in the filter cup 10, the first suction part 421 picks up one side of the filter paper 30 from the filter paper storage module 41. After picking up, it rotates the filter paper 30 to the position corresponding to the filter cup 10, then the second suction part 422 sucks the other side of the filter paper 30, using both the first suction part 421 and the second suction part 422 to spread open the filter paper 30. Afterward, the pressing part 423 applies a force to the filter paper 30, pressing it into the filter cup 10, thus completing the automatic placement of filter paper 30 in the filter cup 10 and achieving the effect of labor savings.

In one embodiment, the coffee powder feeding mechanism 5 includes a storage part 51 and a coffee bean grinding and feeding machine 52. The storage part 51 is mounted above the coffee bean grinding and feeding machine 52. The coffee bean grinding and feeding machine 52 is electrically connected to the operation setting module 21 of the electronic control mechanism 2. Thus, through the settings of the operation setting module 21, coffee beans from the storage part 51 drop into the coffee bean grinding and feeding machine 52 in the required quantity, and the coffee bean grinding and feeding machine 52 grinds the coffee beans to form coffee grounds, which are then collected in the filter cup 10 containing filter paper 30, facilitating the subsequent brewing procedure and thereby achieving the effects of labor savings, maintaining brewing quality, and improving brewing capacity.

In one embodiment, the brewing mechanism 6 includes a water supply module 61, a heating module 62, and a cooling module 63. The heating module 62 is connected to the water supply module 61. The heating module 62 is adapted to be connected to an external water source. The cooling module 63 is mounted on the coffee holding mechanism 7. The water supply module 61, the heating module 62, and the cooling module 63 are electrically connected to the operation setting module 21 of the electronic control mechanism 2, so that the operation setting module 21 manages the related settings for the operation of the water supply module 61, the heating module 62, and the cooling module 63. Thus, the operation setting module 21 drives the heating module 62 to heat the water, and the water supply module 61 supplies hot water to the filter cup 10 containing coffee grounds for coffee brewing, thereby achieving the effects of labor savings, maintaining brewing quality, and improving brewing capacity.

Furthermore, when brewing iced coffee, the operation setting module 21 of the electronic control mechanism 2 can drive the cooling module 63, allowing the cooling module 63 to cool the container 20 in the coffee holding mechanism 7. This cools the brewed coffee in the container 20 to form iced coffee. Since the conventional method of making iced coffee involves adding ice cubes to hot coffee for cooling, while this lowers the temperature to form iced coffee, the melting ice cubes dilute the hot coffee, which directly affects the original flavor of the iced coffee. The present invention uses the cooling module 63 to cool the brewed coffee to form iced coffee without diluting the hot coffee, thereby achieving the effects of labor savings, maintaining brewing quality, and improving brewing capacity.

In one embodiment, the water supply module 61 includes a rotating nozzle 611, and the rotating nozzle 611 has at least three water outlets 612. When the water supply module 61 supplies hot water to the filter cup 10 containing coffee grounds for brewing coffee, the rotating nozzle 611 works in conjunction with the water outlets 612 to simultaneously output hot water to the filter cup 10 containing coffee grounds. The rotating nozzle 611 operates by mimicking a barista brewing techniques, combining the craftsmanship of manual brewing, the precise science of intelligent movement, and the aesthetics of manufacturing craftsmanship. Under this barista-like brewing technique, it precisely controls every detail of the brewing process, and the timing of coffee brewing can be more accurately controlled, ensuring that every brew produces a good cup of coffee.

In one embodiment, the heating module 62 is an instant heating device for receiving water from an external water source and performing two-stage heating to control hot water temperature between 80° C. and 95° C., before transferring the hot water to the water supply module 61 for output. Thus, after receiving water from the external water source, the heating module 62 first quickly heats the cold water from room temperature (about 25° C.) to 75° C. in the first stage heating. Then, it performs the second stage heating on the water that has been heated to 75° C., further heating it to between 80° C. and 95° C. according to different requirements, and precisely controls the hot water temperature within a range of +2° C. (mimicking the four-stage pour-over coffee water temperatures of 95° C., 90° C., 85° C., and 80° C.). This allows the heating module 62 to precisely control the final hot water temperature for brewing coffee, and working in conjunction with the rotating nozzle 611 of the water supply module 61, the rotating nozzle 611 operates by mimicking a barista's brewing techniques, combining the craftsmanship of manual brewing, the precise science of intelligent movement, and the aesthetics of manufacturing craftsmanship. Under this barista-like brewing technique, it precisely controls every detail of the brewing process, and the timing of coffee brewing can be more accurately controlled, ensuring that every brew produces a good cup of coffee.

In one embodiment, the filter cup processing mechanism 8 includes a driving module 81, a clamping module 82, and a cleaning mechanism 83. The clamping module 82 is mounted on the driving module 81, and the cleaning mechanism 83 is located below the support mechanism 1 and located corresponding to the clamping module 82. The driving module 81, the clamping module 82, and the cleaning mechanism 83 are electrically connected to the operation setting module 21, allowing the operation setting module 21 to perform the settings, activation, and related control procedures during operation.

In one embodiment, a waste collection mechanism 9 is mounted below the support mechanism 1 and located corresponding to the filter cup processing mechanism 8. Based on the above embodiment, when the used filter cup 10 moves to the position of the filter cup processing mechanism 8, the driving module 81 drives the clamping module 82 to pick up the filter cup 10, and dumps the filter paper 30 and coffee grounds from the filter cup 10 into the waste collection mechanism 9 through the opening part 13. The clamping module 82 holds the filter cup 10 at the position of the opening part 13, then the cleaning mechanism 83 performs subsequent cleaning of the filter cup 10. Afterward, the driving module 81 drives the clamping module 82 to place the filter cup 10 back in the placement area 32 of the rotating mechanism 3, allowing the support plate 31 to move the filter cup 10 to the position of the coffee filter paper installation mechanism 4, where filter paper 30 is installed in the filter cup 10 for the next brewing use, facilitating the subsequent brewing procedure and thereby achieving the effects of labor savings, maintaining brewing quality, and improving brewing capacity.

While we have shown and described the embodiment in accordance with the present invention, it should be clear to those skilled in the art that further embodiments may be made without departing from the scope of the present invention.

What is claimed is:

1. An automatic coffee brewing device comprising:
a support mechanism;
an electronic control mechanism mounted on the support mechanism;
a rotating mechanism mounted on a top surface of the support mechanism and electrically connected to the electronic control mechanism;
a coffee filter paper installation mechanism mounted on the support mechanism and electrically connected to the electronic control mechanism, the coffee filter paper installation mechanism located corresponding to the rotating mechanism;
a coffee powder feeding mechanism mounted on the support mechanism and electrically connected to the electronic control mechanism, the coffee powder feeding mechanism located corresponding to the rotating mechanism;
a brewing mechanism mounted on the support mechanism and electrically connected to the electronic control mechanism, the brewing mechanism located corresponding to the rotating mechanism;
a coffee holding mechanism mounted on the support mechanism and located corresponding to the brewing mechanism; and
a filter cup processing mechanism mounted on the support mechanism and electrically connected to the electronic control mechanism, the filter cup processing mechanism located corresponding to the rotating mechanism.

2. The automatic coffee brewing device as claimed in claim 1, wherein the support mechanism includes a base and a cover, the electronic control mechanism, the rotating mechanism, the coffee filter paper installation mechanism, the coffee powder feeding mechanism, the brewing mechanism, the coffee holding mechanism, and the filter cup processing mechanism are mounted on the base, the cover is combined with the base, the cover at least encloses the rotating mechanism, the coffee filter paper installation mechanism, the coffee powder feeding mechanism, the brewing mechanism, and the filter cup processing mechanism.

3. The automatic coffee brewing device as claimed in claim 2, wherein the rotating mechanism is located at a central position of a front side of the base, the coffee filter paper installation mechanism is mounted at a rear side of the rotating mechanism, the coffee powder feeding mechanism is correspondingly mounted above the rotating mechanism and adjacent to the coffee filter paper installation mechanism, the brewing mechanism is correspondingly mounted above the rotating mechanism and adjacent to the coffee powder feeding mechanism, the coffee holding mechanism is mounted at a lower front side of the base, and the filter cup processing mechanism is mounted on one side of the rotating mechanism.

4. The automatic coffee brewing device as claimed in claim 1, wherein a waste collection mechanism is mounted below the support mechanism and located corresponding to the filter cup processing mechanism.

5. The automatic coffee brewing device as claimed in claim 1, wherein the electronic control mechanism includes an operation setting module and a pneumatic distribution module, the pneumatic distribution module, the rotating mechanism, the coffee filter paper installation mechanism, the coffee powder feeding mechanism, the brewing mechanism, and the filter cup processing mechanism are electrically connected to the operation setting module, the pneumatic distribution module provides an control air pressure for operation of the coffee filter paper installation mechanism, the brewing mechanism, and the filter cup processing mechanism.

6. The automatic coffee brewing device as claimed in claim 1, wherein the rotating mechanism includes a support plate and multiple placement areas, the placement areas are respectively located on a surface of the support plate, a filter cup is placed on each placement area.

7. The automatic coffee brewing device as claimed in claim 1, wherein the coffee filter paper installation mechanism includes a filter paper storage module and a filter paper picking and placing module, the filter paper storage module is mounted above the filter paper picking and placing module.

8. The automatic coffee brewing device as claimed in claim 7, wherein the filter paper picking and placing module includes a first suction part, a second suction part, and a pressing part, the first suction part and the second suction part are located corresponding to each other, the pressing part is located between the first suction part and the second suction part.

9. The automatic coffee brewing device as claimed in claim 1, wherein the coffee powder feeding mechanism includes a storage part and a coffee bean grinding and feeding machine, the storage part is mounted above the coffee bean grinding and feeding machine.

10. The automatic coffee brewing device as claimed in claim 1 wherein the brewing mechanism includes a water supply module, a heating module, and a cooling module, the heating module is connected to the water supply module, the heating module is adapted to be connected to an external water source, and the cooling module is mounted on the coffee holding mechanism.

11. The automatic coffee brewing device as claimed in claim 10, wherein the water supply module includes a rotating nozzle, and the rotating nozzle has at least three water outlets.

12. The automatic coffee brewing device as claimed in claim 10, wherein the heating module is an instant heating device for receiving water from an external water source and performing two-stage heating to control hot water temperature between 80° C. and 95° C., before transferring the hot water to the water supply module for output.

13. The automatic coffee brewing device as claimed in claim 7, wherein the filter cup processing mechanism includes a driving module, a clamping module, and a cleaning mechanism, the clamping module is mounted on the driving module, and the cleaning mechanism is located below the support mechanism and located corresponding to the clamping module.
